(19) United States
(12) Patent Application Publication
(10) Pub. No.: US 2026/0135115 A1
(43) Pub. Date: May 14, 2026

(54) STRUCTURAL BATTERY FOR VEHICLE

(71) Applicants: Hyundai Motor Company, Seoul (KR); Kia Corporation, Seoul (KR)

(72) Inventor: Won Ki Song, Hwaseong-si (KR)

(21) Appl. No.: 19/336,822

(22) Filed: Sep. 23, 2025

(30) Foreign Application Priority Data
Nov. 11, 2024 (KR) 10-2024-0158993

(51) Int. Cl. H01M 4/66; H01M 4/04; H01M 4/80; H01M 50/46; H01M 50/586; H01M 50/593

(52) U.S. Cl. CPC H01M 4/663; H01M 4/80; H01M 50/46; H01M 50/586; H01M 50/593; H01M 4/0404; H01M 4/0416

(57) ABSTRACT

Provided is a structural battery for an electric vehicle in which a plurality of negative electrode layers, a plurality of electrolyte layers, and a plurality of positive electrode layers are sequentially laminated from top to bottom, wherein the negative electrode layer and the positive electrode layer each include a negative electrode and a positive electrode in which an electrode slurry layer is applied to both surfaces of a carbon fiber current collector layer, and, the carbon fiber current collector layer is formed by impregnating an electrode slurry formed from the electrode slurry layer into an internal porous layer.

### CROSS-REFERENCE TO RELATED APPLICATIONS

This application claims priority to and the benefit of Korean Patent Application No. 10-2024-0158993 filed with the Korean Intellectual Property Office on Nov. 11, 2024, the entire contents of which are incorporated herein by reference.

### TECHNICAL FIELD

The disclosure relates to a structural battery for vehicles, and more particularly, to a structural battery for electric vehicles that may be applied as a member of a vehicle body to mechanically connect parts, while being electrochemically connected with a lithium-ion battery to boost voltage.

### BACKGROUND

Generally, a lithium-ion battery mounted on an electric vehicle occupies a significant portion of the weight of the electric vehicle, but does not perform any load-bearing function at all.

In contrast, as illustrated in FIG. 1, a structural battery 500 is a part that is installed in a frame or structure 800 constituting an electric vehicle 1000 and simultaneously performs own load-bearing and charging/discharging and boosting functions of a high-voltage battery 600 installed on a floor 700 of the vehicle body. In other words, the structural battery 500 may function as a battery while performing the function of an electric vehicle structure.

This battery is also called a massless energy storage device, which is because, when the weight of the battery becomes portion of the load-bearing structure, the weight of the battery storing energy is virtually nonexistent. These composite function batteries may significantly reduce the weight of the vehicle. When the structural battery is applied to electric vehicles, the weight is reduced and a driving range may be improved.

In addition, the structural battery has the capacity of about 20% of the capacity of a lithium-ion battery, which is lower than that of the lithium-ion battery, but the weight is significantly reduced because there is no separate battery, and as a result, the energy required to drive the electric vehicle is reduced. Furthermore, the structural battery has a lower electric energy density and higher stability.

Such a structural battery includes a laminated structure of a negative electrode layer 510 and a positive electrode layer 520, as shown in FIGS. 2 and 3. The negative electrode layer and the positive electrode layer include a negative electrode and a positive electrode, each of which has electrode slurry layers 512 and 522 applied to both surfaces of a carbon fiber current collector layer 530, and glass fiber insulator layers 542 and 544 are provided on an outer portion of the carbon fiber current collector layer 530. An assembly gap G is formed between the electrode slurry layers 512 and 522 and the glass fiber insulator layers 542 and 544 to avoid interference.

Edge portions of the carbon fiber current collector layers 530 are attached to the glass fiber insulation layers 542, 544, and 546 by a resin material 535. At this time, the glass fiber insulation layers 542, 544, and 546 form layers having the same height as the negative electrode slurry layer 512 applied to the upper surface of the carbon fiber current collector layer 530 of the negative electrode layer 510 and positive electrode slurry layer 522 applied to the upper surface of the carbon fiber current collector layer 530 of the positive electrode layer 520, respectively. Accordingly, the assembly gap G provides a gap between the glass fiber insulation layer 542 at the location where the resin material 535 is positioned and the corresponding negative electrode slurry layer 512, and between the glass fiber insulation layer 544 at the location where the resin material 535 is positioned and the corresponding positive electrode slurry layer 522, so that the slurry layers of the negative electrode layer 510 and the positive electrode layer 520 can be prevented from being contaminated.

However, when the assembly gap G is formed, there is a possibility of a short-circuit between the carbon fiber collector layers during the manufacturing of the structural battery due to a fine strand structure of the carbon fiber collector layer 530 and a height tolerance of the upper and lower carbon fiber collector layers 530.

### SUMMARY

The disclosure attempts to provide a structural battery for an electric vehicle, in which an electrode slurry is impregnated into the inside of a carbon fiber current collector layer in a structural battery having a series-connected structure to improve energy density and an electrolyte layer coating that extends to an outer region of the carbon fiber current collector layer to prevent interference between carbon fiber current collector layers.

According to an exemplary embodiment, there is provided a structural battery for an electric vehicle in which a plurality of negative electrode layers, a plurality of electrolyte layers, and a plurality of positive electrode layers are sequentially laminated from top to bottom, wherein the negative electrode layer and the positive electrode layer each include a negative electrode and a positive electrode in which an electrode slurry layer is applied to both surfaces of a carbon fiber current collector layer, and, the carbon fiber current collector layer is formed by impregnating an electrode slurry formed from the electrode slurry layer into an internal porous layer.

The carbon fiber current collector layer may be formed to have a region extending further outward than the electrode slurry layer.

The electrolyte layer may include a solid electrolyte coated on upper and lower surfaces of the electrode slurry layer.

The electrolyte layer may be formed to extend to and coat a region of the carbon fiber current collector layer further outward than the electrode slurry layer.

The electrolyte layer may be formed to extend to and coat a side surface the electrode slurry layer and a side surface of the carbon fiber current collector layer on the same vertical line as the side surface of the electrode slurry layer.

Edge portions of the negative electrode layer and the positive electrode layer may be impregnated with resin and sealed.

At an edge of the negative electrode layer and the positive electrode layer, a glass fiber insulating layer having a region extending further outward than the carbon fiber current collector layer may be provided.

An inner portion of the glass fiber insulation layer may be attached to an edge portion of the carbon fiber current collector layer by a resin material.

An assembly gap consisting of a space may be formed between the glass fiber insulation layer at the location where the resin material is positioned and the electrode slurry layer.

The negative electrode may be formed by applying a negative electrode slurry layer to both surfaces of the carbon fiber current collector layer, and the positive electrode may be formed by applying a positive electrode slurry layer to both surfaces of the carbon fiber current collector layer.

The negative electrode slurry layer may include a negative electrode active material, a binder, and a conductive agent, and the positive electrode slurry layer may include a positive electrode active material, a binder, and a conductive agent.

A carbon fiber structural reinforcement layer may be laminated on an outer portion of each of outermost upper and lower negative electrode layers.

A pouch film may be laminated between the outermost upper and lower negative electrode layers and the carbon fiber structure reinforcement layer.

A glass fiber structure reinforcement layer may be laminated between the outer portion of each of the outermost upper and lower negative electrode layers and the carbon fiber structure reinforcement layer.

According to the disclosure, in a structural battery having a series-connected structure, the energy density may be improved by impregnating the inside of the carbon fiber collector layer with electrode slurry, thereby increasing the cell efficiency to reduce the cost.

In addition, by coating a solid electrolyte on the carbon fiber current collector layer and the electrode slurry layer and forming an assembly gap between the electrode slurry layer and the glass fiber insulator layer, contamination of the electrode slurry layer may be prevented during hot pressing, and occurrence of a short-circuit between the carbon fiber current collector layers may be prevented.

In addition, by installing the structural battery that functions as a battery in the frame structure of the vehicle, a battery space may be saved, the layout may be improved, weight may be reduced, and fuel efficiency may be improved, and thus, the marketability of the vehicle may be improved.

### BRIEF DESCRIPTION OF THE DRAWINGS

FIG. 1 is a schematic diagram of an electric vehicle to which a structural battery for an electric vehicle according to an exemplary embodiment of the disclosure is applied.

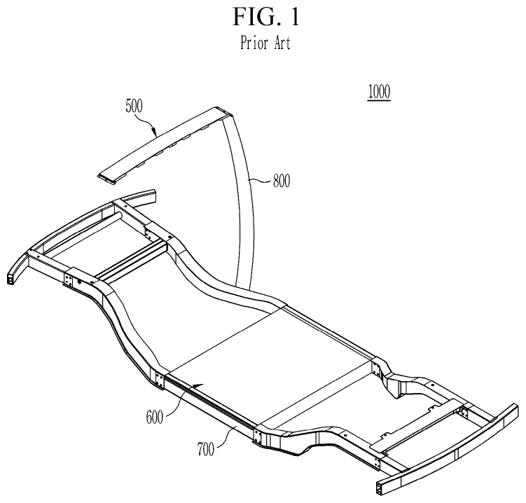

FIG. 2 is a diagram illustrating a laminated structure of a negative electrode and a positive electrode for an electric vehicle according to an exemplary embodiment of the disclosure and the related art.

FIG. 3 is a diagram illustrating the laminated structure of an existing structural battery for an electric vehicle.

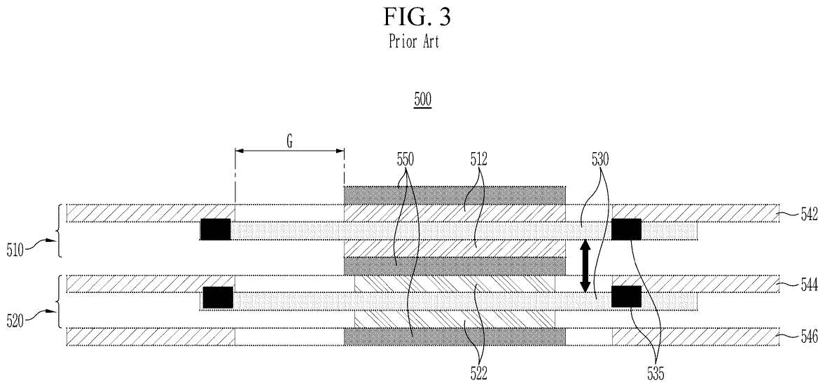

FIG. 4 is a diagram illustrating a cross-sectional structure of a structural battery for an electric vehicle according to an exemplary embodiment of the disclosure.

FIG. 5 is a diagram illustrating an example of a laminated structure of a structural battery for an electric vehicle according to an exemplary embodiment of the disclosure.

FIG. 6 is a diagram illustrating a cross-sectional structure of a structural battery for an electric vehicle according to another exemplary embodiment of the disclosure.

FIG. 7 is a diagram illustrating a laminated structure of a structural battery for an electric vehicle according to another exemplary embodiment of the disclosure.

### DETAILED DESCRIPTION OF ILLUSTRATIVE EMBODIMENTS

Hereinafter, reference will be now made to the exemplary embodiments of the disclosure with reference to the attached drawings in a manner sufficiently detail to be readily carried out by a person skilled in the art, to which the disclosure pertains. As those skilled in the art would realize, the described exemplary embodiments may be modified in various different ways, all without departing from the spirit or scope of the disclosure.

In various exemplary embodiments, components having the same configuration are representatively described in an exemplary embodiment using the same reference numerals, and in other exemplary embodiments, only components that are different from the exemplary embodiment are described.

It should be noted that the drawings are schematically illustrated but not scaled in proportion. Therefore, in the attached drawings, the relative dimensions and proportions of the components are illustrated to be more enlarged or reduced than they actually are in order to clarify the disclosure, and a certain size is just illustrative but not limited thereto. In the drawings, the same structures, elements or parts have the same reference numerals so as to denote similar features even though they are illustrated in different figures. When it is said that any portion is positioned “on” another part, it means the portion is directly on the other portion or above the other portion with at least one intermediate part.

Exemplary embodiments specifically show preferred exemplary embodiments. As a result, various modifications of the drawings are anticipated. Therefore, the exemplary embodiments are not limited to a specific form of an illustrated region, and for example, include modifications of a manufactured form.

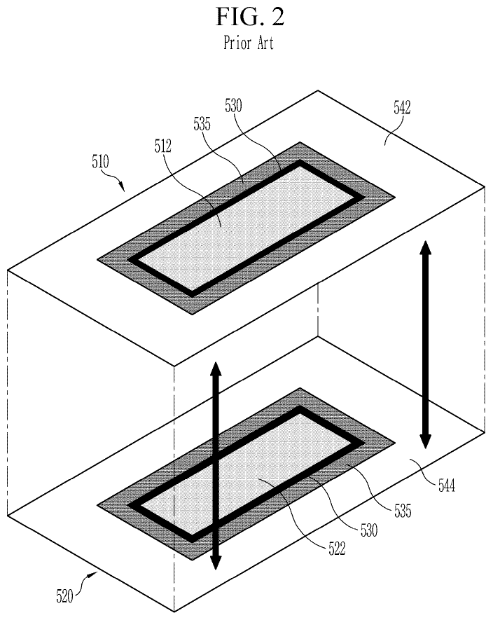

Hereinafter, a structural battery for an electric vehicle according to the disclosure will be described with reference to FIGS. 2, 4 to 7.

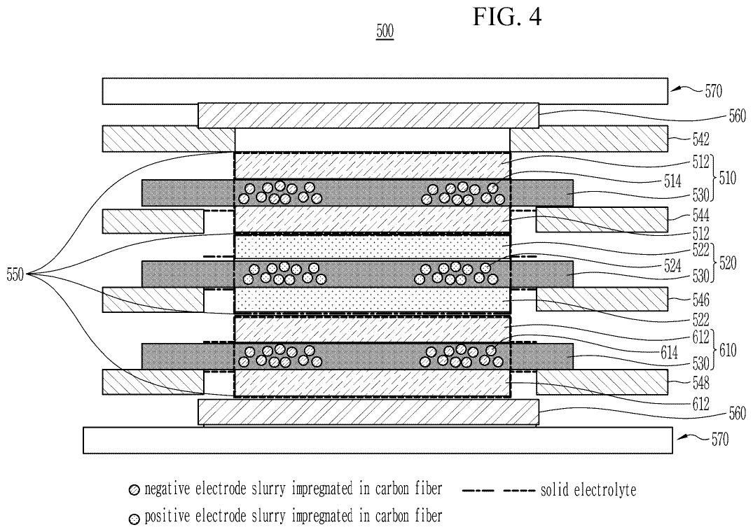

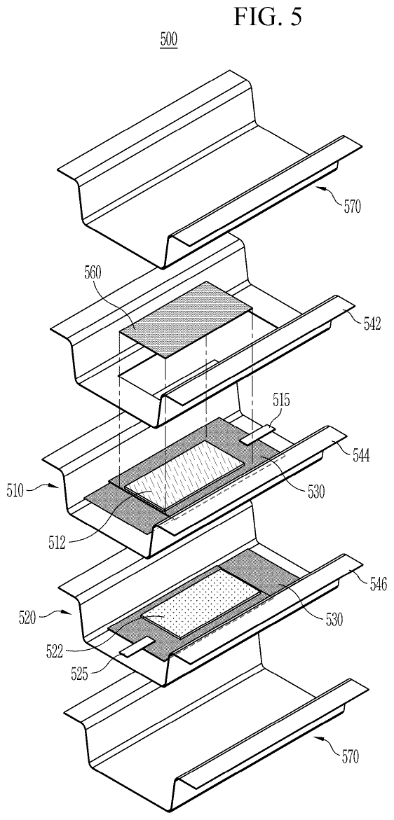

FIG. 2 is a diagram illustrating a laminated structure of a negative electrode and a positive electrode for an electric vehicle according to an exemplary embodiment of the disclosure, FIG. 4 is a diagram illustrating a cross-sectional structure of a structural battery for an electric vehicle according to an exemplary embodiment of the disclosure, and FIG. 5 is a diagram illustrating an example of a laminated structure of a structural battery for an electric vehicle according to an exemplary embodiment of the disclosure.

First, referring to FIG. 2, a structural battery for an electric vehicle according to an exemplary embodiment of the disclosure is formed by sequentially laminating a plurality of negative electrode layers 510, a plurality of electrolyte layers 550 (e.g., as shown in FIG. 4), and a plurality of positive electrode layers 520 from top to bottom.

The negative electrode layer 510 and the positive electrode layer 520 include a negative electrode and a positive electrode in which electrode slurry layers 512 and 522 are applied to be formed on both surfaces of a carbon fiber current collector layer 530. The negative electrode is formed by applying the negative electrode slurry layer 512 to both surfaces of the carbon fiber current collector layer 530, and the positive electrode is formed by applying the positive electrode slurry layer 522 to both surfaces of the carbon fiber current collector layer 530.

The negative electrode slurry layer 512 may include a negative electrode active material, a binder, and a conductive agent, and the positive electrode slurry layer 522 may include a positive electrode active material, a binder, and a conductive agent. The negative electrode slurry layer 512 and the positive electrode slurry layer 522 may additionally include a conductive agent to supplement the conductivity of the negative electrode active material and the positive electrode active material, and the conductivity of the electrode active material may be improved by bonding each electrode active material and the conductive agent with a binder.

The negative electrode may include the negative electrode slurry layer 512 and the negative electrode carbon fiber current collector layer 530, and the positive electrode may include the positive electrode slurry layer 522 and the positive electrode carbon fiber current collector layer 530. The negative electrode and the positive electrode may respectively constitute the negative electrode layer 510 and the positive electrode layer 520, and the negative electrode layer 510 and the positive electrode layer 520 may be connected by the electrolyte layers 550 (e.g., as shown in FIG. 4) therebetween.

The electrolyte layers 550 (e.g., as shown in FIG. 4) may allow lithium ions to pass therethrough and block electrons, thereby implementing a redox reaction between the positive and negative electrodes, and may include a solid electrolyte.

Glass fiber insulator layers (prepregs) 542 and 544 may be provided at an edge of each negative electrode layer 510 and each positive electrode layer 520. The prepreg may be a fiber impregnated with a resin and may be formed of a non-conductive glass fiber insulating between the carbon fiber current collector layers 530. The glass fiber insulator layers 542 and 544 may have a quadrangular opening formed in the center so as to be attached to four edge portions of the carbon fiber current collector 530. In a cross-section, the glass fiber insulator layers 542 and 544 and the electrode slurry layers 512 and 522 are spaced apart from each other by a certain distance, and the electrode slurry layers 512 and 522 and the carbon fiber current collector layer 530 are exposed through openings of the glass fiber insulator layers 542 and 544.

Meanwhile, the carbon fiber current collector layer 530 may have a region extending further toward the outside than the negative electrode slurry layer 512 and the positive electrode slurry layer 522. In addition, the edge portions of the negative electrode layer 510 and the positive electrode layer 520 may be impregnated with resin and sealed.

A negative electrode tab 515 and a positive electrode tab 525 may each be connected to the carbon fiber current collector 530 and may be positioned to extend from the inside to the outside of the sealed region (see FIG. 5). That is, connection portions of the negative electrode tab 515 and the positive electrode tab 525 with the carbon fiber current collector layer 530 are located inside the conductive sealing region. The resin-impregnated region is a region in which electricity does not flow, mechanical strength is improved, and moisture, etc. does not penetrate from the outside.

The glass fiber insulator layers 542 and 544 having a region extending further outward than the carbon fiber current collector layer 530 are provided at the edges of the negative electrode layer 510 and the positive electrode layer 520.

Referring to FIGS. 4 and 5, negative electrode layers 510 and 610 and the positive electrode layer 520 may be laminated in a vertical direction, and the plurality of negative electrode layers 510 and 610 and positive electrode layer 520 may be alternately and sequentially laminated. The electrolyte layer 550 is laminated between the plurality of negative electrode layers 510 and 610 and positive electrode layer 520 to allow lithium ions to pass between the negative electrode layers 510 and 610 and positive electrode layer 520 and block electrons, thereby implementing a redox reaction between the negative electrode and the positive electrode.

The electrolyte layer 550 may include a solid electrolyte coated on upper and lower surfaces of the electrode slurry layers 512, 522, and 612. The electrolyte layer 550 may be formed to extend to and coat a region further extending outward than the electrode slurry layers 512, 522, and 612 of the carbon fiber current collector layer 530. In addition, the electrolyte layer 550 may be formed to extend to and coat side surfaces of the electrode slurry layer 512, 522, and 612 and the side surface of the carbon fiber current collector layer 530 on the same vertical line as the side surfaces of the electrode slurry layer 512, 522, and 612.

In this manner, by coating a solid electrolyte on the carbon fiber current collector layer 530 and the electrode slurry layers 512, 522, and 612 and forming an assembly gap between the electrode slurry layers 512, 522, and 612 and the glass fiber insulator layers 542 and 544, contamination of the electrode slurry layers 512, 522, and 612 may be prevented during hot pressing, and occurrence of a short-circuit between the carbon fiber current collector layers 530 may be prevented.

Meanwhile, the carbon fiber current collector layer 530 may be formed by impregnating an internal porous layer with the electrode slurry formed from the electrode slurry layer 512, 522, and 612. The electrode slurry layers 512, 522, and 612 may be coated on both surfaces of the carbon fiber current collector layer 530, and an electrode slurry may be impregnated into the internal porous layer of the carbon fiber current collector layer 530, thereby improving energy density at the same thickness of the carbon fiber current collector layer 530. Through this, the cell efficiency may be increased, thereby reducing the cost. In the existing lithium battery, an electrode slurry capacity equivalent to the thickness of an aluminum current collector cannot be applied, but in the structural battery according to the disclosure, the carbon fiber current collector 530 is impregnated with the electrode slurry layers 512, 522, and 612, thereby increasing the electron energy density.

As shown in FIGS. 4 and 5, in the structure of the structural battery for an electric vehicle according to an exemplary embodiment of the disclosure in which the plurality of negative electrode layers 510 and 610 and the plurality of positive electrode layers 520 are alternately laminated, a carbon fiber structure reinforcement layer 570 may be laminated on each of outer portions of the outermost upper and lower negative electrode layers 510 and 610. The carbon fiber structure reinforcement layer 570 may include a plurality of layers, and a pouch film 560 may be laminated between the outer portion of each of the outermost upper and lower negative electrode layers 510 and 610 and the carbon fiber structure reinforcement layer 570.

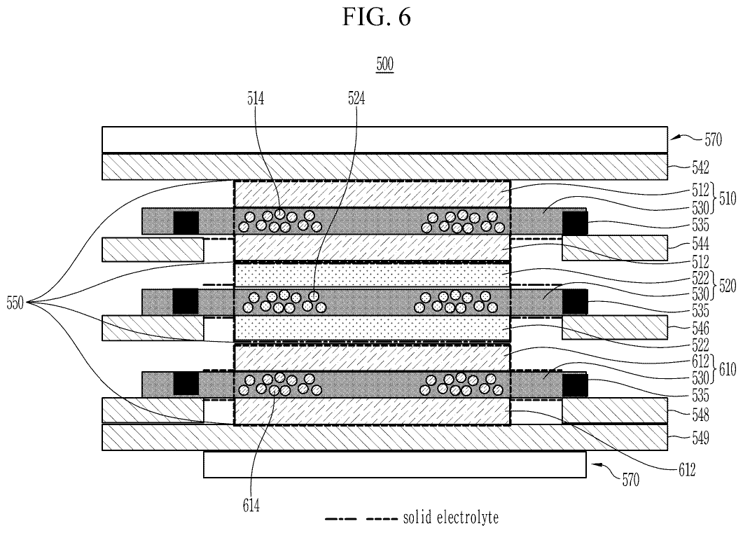

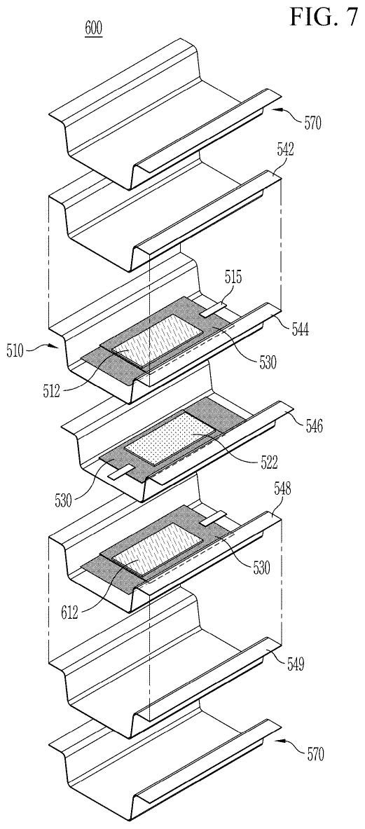

FIG. 6 is a diagram illustrating a cross-sectional structure of a structural battery for an electric vehicle according to another exemplary embodiment of the disclosure, and FIG. 7 is a diagram illustrating a laminated structure of a structural battery for an electric vehicle according to another exemplary embodiment of the disclosure.

Referring to FIGS. 6 and 7, in the structural battery for an electric vehicle according to another exemplary embodiment of the disclosure, the plurality of negative electrode layers 510 and 610 and the positive electrode layer 520 are sequentially and alternately laminated in the vertical direction, and the electrolyte layer 550 is laminated between the plurality of negative electrode layers 510 and 610 and the positive electrode layer 520.

The electrolyte layer 550 may be formed of a solid electrolyte coated on the upper and lower surfaces of the electrode slurry layers 512, 522, and 612 and may be formed to extend to and coat a region extending further outward than the electrode slurry layers 512, 522, and 612 of the carbon fiber current collector layer 530. Additionally, the electrolyte layer 550 may be formed by coating and extending to the side surface of the electrode slurry layers 512, 522, and 612 and the side surface of the carbon fiber current collector layer 530 on the same vertical line as the side surface of the electrode slurry layers 512, 522, and 612.

The carbon fiber current collector layer 530 may be formed by impregnating the internal porous layer with the electrode slurry formed from the electrode slurry layers 512, 522, and 612, and inner upper portions of glass fiber insulator layers 544, 546, and 548 may be attached to a lower portion of the edge of the carbon fiber current collector layer 530 by a resin material 535. At this time, the resin material 535 is not coated with electrolyte.

An assembly gap having a predetermined interval is formed between the glass fiber insulation layers 544, 546, and 548 and the electrode slurry layers 512, 522, and 612 at the location of the resin material 535. This assembly gap can prevent the electrode slurry layers 512, 522, and 612 from being contaminated by the electrode slurry 514 and 614 impregnated into the carbon fiber current collector layer 530 spreading during heat fusion by hot pressing. In addition, an assembly gap of an appropriate distance between the electrolyte layer 550 coated on the side of the electrode slurry layers 512, 522, and 612 and the side of the carbon fiber current collector layer 530 on the same vertical line as the side of the electrode slurry layers 512, 522, and 612 and the resin material 535 may be formed to prevent contamination of the electrode slurry layers 512, 522, and 612.

In the structure in which the plurality of negative electrode layers 510 and 610 and positive electrode layer 520 are alternately laminated, the carbon fiber structure reinforcement layer 570 may be laminated on the outer portion of each of the outermost upper and lower negative electrode layers 510 and 610. In addition, glass fiber structure reinforcement layers 542 and 549 may be laminated between an outer portion of each of the outermost upper and lower negative electrode layers 510 and 610 and the carbon fiber structure reinforcement layer 570. In the present exemplary embodiment, unlike the exemplary embodiments illustrated in FIGS. 4 and 5, a structure in which the pouch film is omitted and the glass fiber structure reinforcement layers 542 and 549 are laminated is disclosed.

The negative electrode tab 515 and the positive electrode tab 525 are each connected to the carbon fiber current collector 530 and may be positioned to extend from the inside to the outside of the region impregnated with resin and sealed.

In this manner, according to the disclosure, in the structural battery having a series-connected structure, the energy density may be improved by impregnating the inside of the carbon fiber collector layer with electrode slurry, thereby increasing the cell efficiency to reduce the cost.

In addition, by coating a solid electrolyte on the carbon fiber current collector layer and the electrode slurry layer and forming an assembly gap between the electrode slurry layer and the glass fiber insulator layer, contamination of the electrode slurry layer may be prevented during hot pressing, and occurrence of a short-circuit between the carbon fiber current collector layers may be prevented.

In addition, by installing the structural battery that functions as a battery in the frame structure of the vehicle, a battery space may be saved, the layout may be improved, weight may be reduced, and fuel efficiency may be improved, and thus, the marketability of the vehicle may be improved.

While this invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

### DESCRIPTION OF SYMBOLS

1000: electric vehicle
500: structural battery for electric vehicle
510, 610: negative electrode layer
512, 612: negative electrode slurry layer
515: negative electrode tab
520: positive electrode layer
522: positive electrode slurry layer
525: positive electrode tab
530: carbon fiber current collector layer
535: resin material
542, 544, 546, 548: glass fiber insulator layer
542, 549: glass fiber structure reinforcement layer
550: electrolyte layer
560: pouch film
570: carbon fiber structure reinforcement layer

What is claimed is:

1. A structural battery for an electric vehicle, comprising:
a plurality of negative electrode layers;
a plurality of electrolyte layers; and
a plurality of positive electrode layers,
wherein:
the plurality of negative electrode layers, the plurality of electrolyte layers, the plurality of positive electrode layers and are sequentially laminated from top to bottom,
a negative electrode layer of the plurality of negative electrode layers and a positive electrode layer of the plurality of positive electrode layers each include a negative electrode and a positive electrode in which an electrode slurry layer is applied to both surfaces of a carbon fiber current collector layer, and
the carbon fiber current collector layer is formed by impregnating an electrode slurry formed from the electrode slurry layer into an internal porous layer.

2. The structural battery of claim 1, wherein:
the carbon fiber current collector layer is formed to have a region extending further outward than the electrode slurry layer.

3. The structural battery of claim 2, wherein:
an electrolyte layer of the plurality of electrolyte layers includes a solid electrolyte coated on upper and lower surfaces of the electrode slurry layer.

4. The structural battery of claim 3, wherein:
the electrolyte layer is formed to extend to and coat the region of the carbon fiber current collector layer further outward than the electrode slurry layer.

5. The structural battery of claim 4, wherein:
the electrolyte layer is formed to extend to and coat a first side surface the electrode slurry layer and a second side surface of the carbon fiber current collector layer on a same vertical line as a side of the electrode slurry layer.

6. The structural battery of claim 1, wherein:
edge portions of the plurality of negative electrode layers and the plurality of positive electrode layers are impregnated with resin and sealed.

7. The structural battery of claim 6, wherein:
at an edge of a negative electrode layer of the plurality of negative electrode layers and a positive electrode layer of the plurality of positive electrode layers, a glass fiber insulating layer having a region extending further outward than the carbon fiber current collector layer is provided.

8. The structural battery of claim 7, wherein:
an inner portion of the glass fiber insulation layer is attached to an edge portion of the carbon fiber current collector layer by a resin material.

9. The structural battery of claim 8, wherein:
an assembly gap consisting of a space is formed between the glass fiber insulation layer at a location where the resin material is positioned and the electrode slurry layer.

10. The structural battery of claim 1, wherein:
the negative electrode is formed by applying a negative electrode slurry layer to both surfaces of the carbon fiber current collector layer, and the positive electrode is formed by applying a positive electrode slurry layer to both surfaces of the carbon fiber current collector layer.

11. The structural battery of claim 10, wherein:
the negative electrode slurry layer includes a negative electrode active material, a first binder, and a first conductive agent, and
the positive electrode slurry layer includes a positive electrode active material, a second binder, and a second conductive agent.

12. The structural battery of claim 1, wherein:
a carbon fiber structural reinforcement layer is laminated on an outer portion of each of outermost upper and lower negative electrode layers.

13. The structural battery of claim 12, wherein:
a pouch film is laminated between outermost upper and lower negative electrode layers and the carbon fiber structure reinforcement layer.

14. The structural battery of claim 12, wherein:
a glass fiber structure reinforcement layer is laminated between the outer portion of each of the outermost upper and lower negative electrode layers and the carbon fiber structure reinforcement layer.

15. A structural battery for an electric vehicle, comprising:
a negative electrode layer, comprising:
a first carbon fiber current collector layer comprising a first top surface and a first bottom surface; and
a first electrode slurry layer applied to the first top surface and the first bottom surface,
wherein the first carbon fiber current collector layer is formed by impregnating a first electrode slurry from the first electrode slurry layer into a first internal porous layer of the first carbon fiber current collector layer;
an electrolyte layer; and
a positive electrode layer, comprising:
a second carbon fiber current collector layer comprising a second top surface and a second bottom surface; and
a second electrode slurry layer applied to the second top surface and the second bottom surface,
wherein the second carbon fiber current collector layer is formed by impregnating a second electrode slurry from the second electrode slurry layer into a second internal porous layer of the second carbon fiber current collector layer,
wherein:
the negative electrode layer, the electrolyte layer, and the positive electrode layer are sequentially laminated from a top to a bottom of the structural battery.

16. The structural battery of claim 15, wherein:
the first carbon fiber current collector layer is formed to have a first region extending further outward than the first electrode slurry layer, and
the second carbon fiber current collector layer is formed to have a second region extending further outward than the second electrode slurry layer.

17. The structural battery of claim 15, wherein the electrolyte layer comprises a solid electrolyte.

18. The structural battery of claim 15, wherein:
a first edge portion of the negative electrode layer and a second edge portion of the positive electrode layer are impregnated with resin and sealed.

19. The structural battery of claim 15, wherein:
the first electrode slurry layer comprises:
a negative electrode active material;
a first binder; and
a first conductive agent, and
the second electrode slurry layer comprises:
a positive electrode active material;
a second binder; and
a second conductive agent.

20. The structural battery of claim 15, wherein:
a first glass fiber insulating layer having a first region extending further outward than the first carbon fiber current collector layer is provided at a first edge of the negative electrode layer, and
a second glass fiber insulating layer having a second region extending further outward than the second carbon fiber current collector layer is provided at a second edge of the positive electrode layer.
